(19) United States
(12) Patent Application Publication
(10) Pub. No.: US 2026/0051092 A1
(43) Pub. Date: Feb. 19, 2026

(54) SEAMLESS IMAGE EDITS USING CROSS-FRAME ATTENTION

(71) Applicant: ADOBE INC., SAN JOSE, CA (US)

(72) Inventors: Hadi Alzayer, College Park, MD (US); Zhihao Xia, Sunnyvale, CA (US); Xuaner Zhang, Los Gatos, CA (US); Elya Shechtman, Seattle, WA (US); Michaël Gharbi, San Francisco, CA (US)

(21) Appl. No.: 18/808,730

(22) Filed: Aug. 19, 2024

(51) Int. Cl. G06T 11/60; G06T 7/10; G06V 10/44

(52) U.S. Cl. CPC G06T 11/60; G06T 7/10; G06V 10/44; G06T 2207/20081

(57) ABSTRACT

A method, apparatus, non-transitory computer readable medium, and system for generating a seamless version of a coarse edit image includes obtaining a reference image, the coarse edit image, and an occlusion mask. The coarse edit image depicts an object from the reference image at a target position, and the occlusion mask indicates an occluded region of the coarse edit image. Embodiments then extract, using a detail extraction model of an image generation model, detail features from the reference image based on the occlusion mask. Subsequently, embodiments generate, using the image generation model, a synthetic image depicting the object at the target position based on the coarse edit image by performing cross-frame attention between the detail features and the coarse edit image.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. In some cases, a DDPM can be conditioned on a text description, such that the diffusion process generates images that match the text. In some cases, additional conditioning beyond the text description may be applied to generate images that conform to a particular pose or lighting, for example.

### SUMMARY

Embodiments of the inventive concepts described herein include systems and methods for generating a seamless version of a coarsely edited image. The image may be edited by, for example, a user that performs various transforms on regions of the image. Embodiments include an image generation model that includes a detail extraction model and a synthesizer model. The detail extraction model performs a denoising process on a noised version of the unedited image during inference. The synthesizer model performs a re-generation of the coarsely edited image by denoising a noised version of the coarsely edited image. Both models are provided with an occlusion mask that indicates regions with missing information due to the editing. Throughout the inference process, features from the detail extraction model that encode detail from the unedited image are combined with features from the synthesizer model using a cross-frame attention process. According to some aspects, the cross-frame attention process enables the synthesizer model to re-generate the coarsely edited image while incorporating relevant visual information from the unedited image, such as proper lighting, reflections, semantic details, and other attributes.

According to some aspects, the image generation model, including the detail extraction model and the synthesizer model, are trained using frames from training videos. For example, a first frame is used to represent the unedited image, and a second frame is used to represent a ground-truth target for the image generation model to generate. The second frame may, for example, include an object from the first frame that has moved or resized at a later time in the video. A motion model is used to simulate the corresponding coarse edit image resulting from transforming the object, e.g., by a user of an image editing application. Accordingly, the training process teaches the image generation model to regenerate seamless versions of the coarse edit image.

A method, apparatus, non-transitory computer readable medium, and system for image generation are described. One or more aspects of the method, apparatus, non-transitory computer readable medium, and system include obtaining a reference image, a coarse edit image, and an occlusion mask, wherein the coarse edit image depicts an object from the reference image at a target position, and the occlusion mask indicates an occluded region of the coarse edit image; extracting, using a detail extraction model of an image generation model, detail features from the reference image based on the occlusion mask; and generating, using the image generation model, a synthetic image depicting the object at the target position based on the coarse edit image by performing cross-frame attention between the detail features and image features representing the coarse edit image.

A method, apparatus, non-transitory computer readable medium, and system for training an image generation model are described. One or more aspects of the method, apparatus, non-transitory computer readable medium, and system include obtaining training data including a reference image, a coarse edit image, an occlusion mask, and a ground truth image, wherein the coarse edit image depicts an object from the reference image at a target position, the occlusion mask indicates an occluded region of the coarse edit image, and the ground truth image depicts the object at the target position and training, using the training data, the image generation model to generate a synthetic image depicting the object at the target position based on detail features representing the reference image.

An apparatus, system, and method for image generation are described. One or more aspects of the apparatus, system, and method include at least one processor; at least one memory storing instructions executable by the at least one processor; and an image generation model comprising parameters stored in the at least one memory and trained to extract detail features from a reference image and an occlusion mask, and to generate a synthetic image based on a coarse edit image that depicts an object from the reference image at a target position, wherein the synthetic image depicts the object at the target position.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of an image generation pipeline according to aspects of the present disclosure.

FIG. 4 shows an example of cross-frame attention according to aspects of the present disclosure.

FIG. 5 shows an example of a segmentation component according to aspects of the present disclosure.

FIG. 6 shows an example of a guided latent diffusion model according to aspects of the present disclosure.

FIG. 7 shows an example of a U-Net architecture according to aspects of the present disclosure.

FIG. 8 shows an example of a diffusion process according to aspects of the present disclosure.

FIG. 9 shows an example of a method for generating a synthetic image based on a coarse edit image according to aspects of the present disclosure.

FIG. 10 shows an example of a method for providing a synthetic image to a user according to aspects of the present disclosure.

FIG. 11 shows an example of a pipeline for generating image generation data according to aspects of the present disclosure.

FIG. 12 shows an example of a training pipeline according to aspects of the present disclosure.

FIG. 13 shows an example of a training algorithm for a machine learning model according to aspects of the present disclosure.

FIG. 14 shows an example of a method a method for training a diffusion model according to aspects of the present disclosure.

FIG. 15 shows an example of a method a method for training a machine learning model to generate synthetic images according to aspects of the present disclosure.

FIG. 16 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention. Generative models in ML are algorithms designed to generate new data samples that resemble a given dataset. Generative models are used in various fields, including image generation. They work by learning patterns, features, and distributions from a dataset and then using this understanding to produce new, original outputs.

Image editing can be a labor-intensive process. Although users can quickly and easily rearrange parts of an image to compose a new one, simple edits can easily look unrealistic when the scene lighting and physical interactions between objects become inconsistent. Fixing these issues manually to make the edit plausible can use significant time and skill, and sometimes involve pixel level edits. Image edits can include various operations on image content such as cropping, resizing, adjusting brightness and contrast, and removing unwanted elements. In some cases, these methods also involve more complex tasks like retouching, compositing, and color correction.

Recently, users have applied generative ML systems to image editing. Some generative methods provide explicit spatial keypoints control, e.g., to adjust poses and positions of scene elements, but are either limited to certain domains or modest changes. Some approaches regenerate pixels based on a user-specified text prompt and a mask of the region to influence. However, this interface is not always natural. It does not allow for spatial transformations of the existing scene content, making it challenging for users to achieve the desired edits without extensive adjustments. For example, this approach does not allow a user to select a scene element and make direct adjustments thereto; rather, this limits the user to simply replacing the scene element with generated content. Furthermore, current generative models may struggle with maintaining consistency in scene lighting, reflections, and other semantic details when performing complex edits.

Embodiments of the present disclosure improve the accuracy of image generation models used in editing tasks. An image generation model is trained to generate a synthetic image from a coarsely edited input image, where the synthetic image seamlessly incorporates details from the original unedited image, ensuring consistent lighting, reflections, and other semantic attributes. Embodiments automatically segment an input image into editable elements, allowing a user to make transforms to each element such as deletion, duplication, resizing, and movements, to form the coarse edit image. The editing process yields the original image, the coarse edit image, and an occlusion mask that represents the areas which lack information after the edits. A detail extraction model of the image generation model provides detail features during the generation of the synthetic image, ensuring that the synthetic image does not include out-of-context or otherwise unfit content.

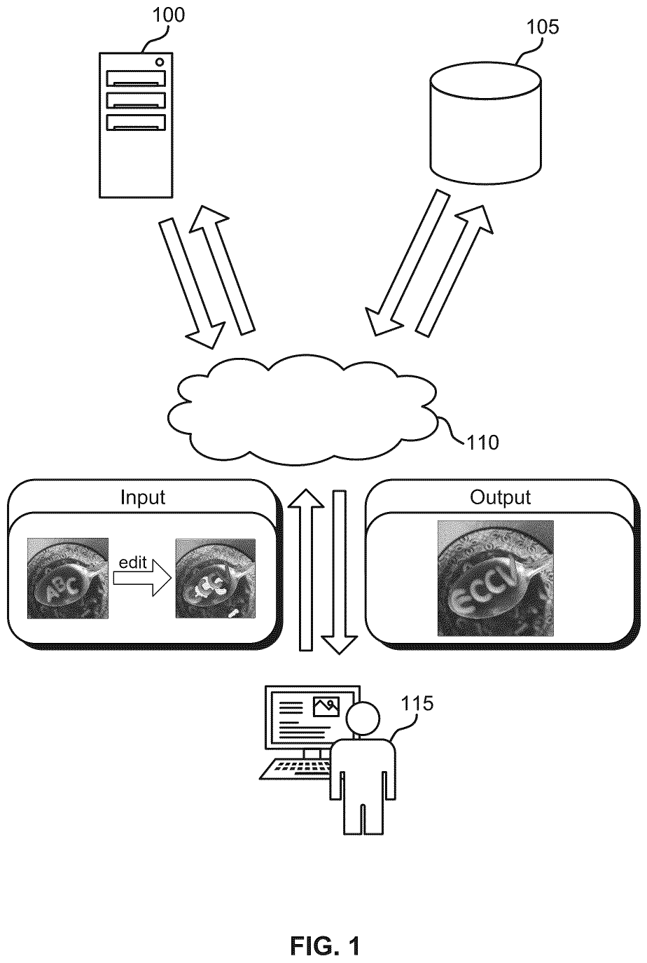

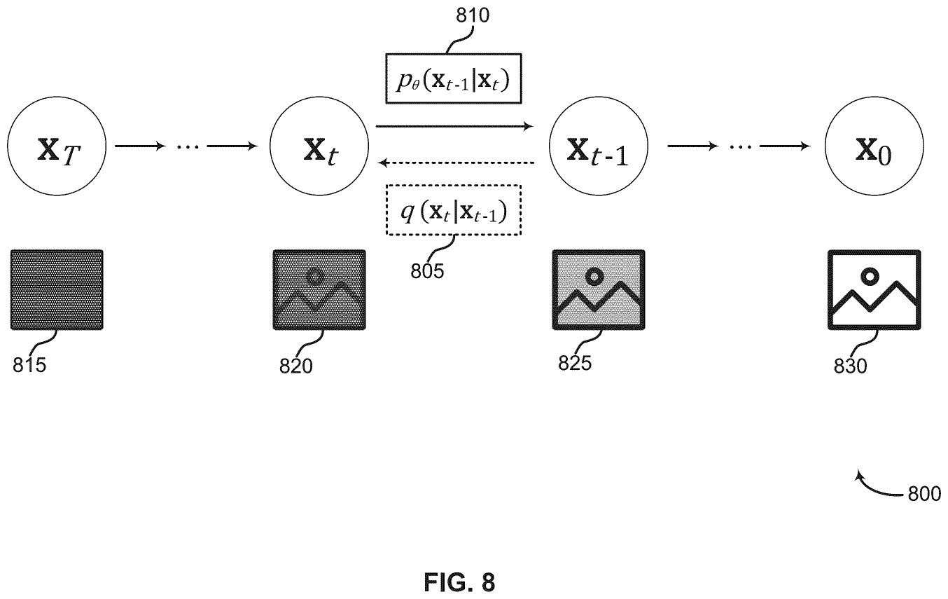

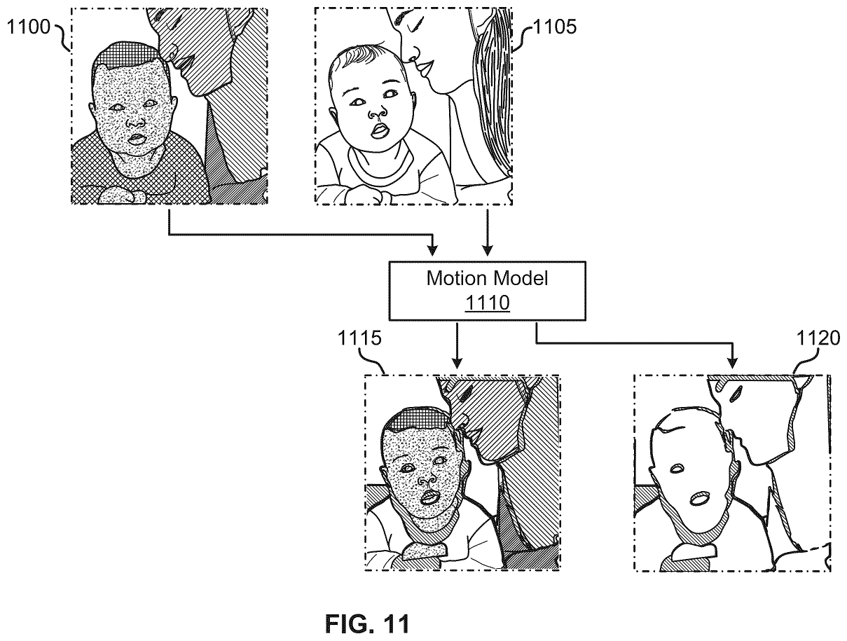

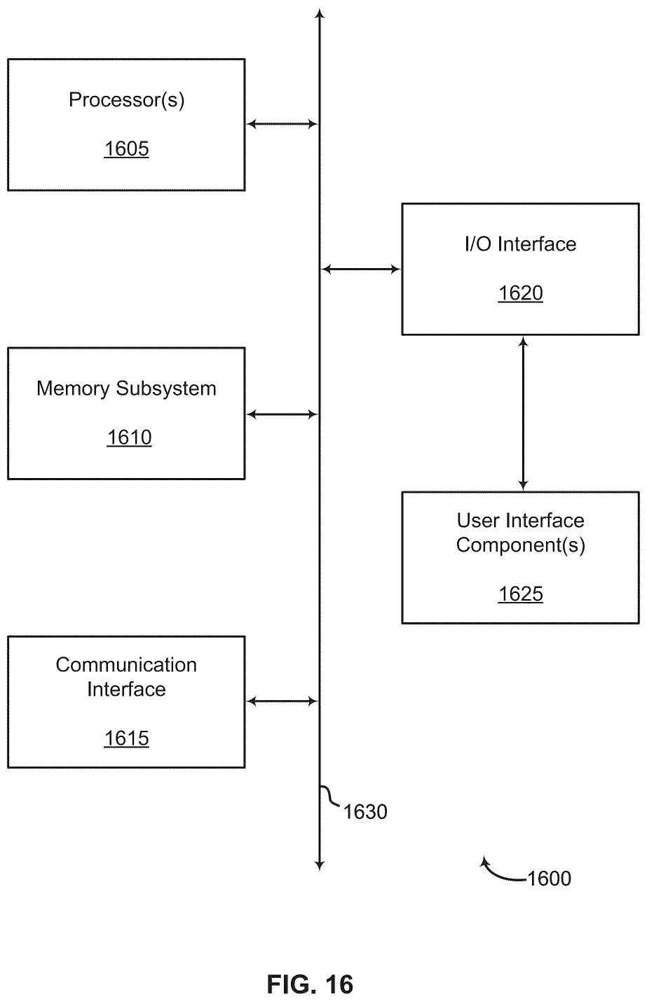

An image processing system is described with reference to FIGS. 1-7. Methods for generating seamless synthetic images from a coarse edit image are described with reference to FIGS. 8-10. Methods for training the image processing system are described with reference to FIGS. 11-15. A computing device configured to implement an image processing apparatus is described with reference to FIG. 16.

### Image Processing System

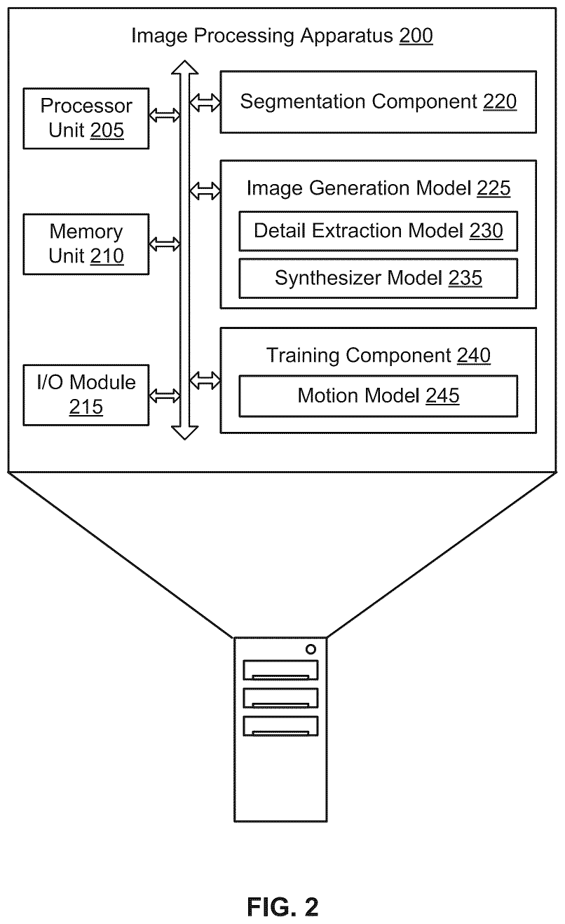

FIG. 1 shows an example of an image processing system according to aspects of the present disclosure. The example shown includes image processing apparatus 100, database 105, network 110, and user 115. Image processing apparatus 100 is an example of, or includes aspects of, the corresponding element described with reference to FIG. 2. In this example, user 115 edits an image by rearranging elements from an original image to form a coarse edit image. Particularly, the user removes the letters ‘A’ and ‘B’ from the soup spoon, and copies the ‘C’ multiple times, and uses a piece of stray noodle to form a rough mockup of the letters ‘ECCV’ on the spoon. The image processing apparatus 100 then processes the original image, the coarse edit image, and an occlusion mask that was derived from the editing process to generate a synthetic image that depicts a seamless version of the coarse edit image, and provides the synthetic image to user 115.

Embodiments of image processing apparatus 100 include components that are implemented on a server. A server provides one or more functions to users linked by way of one or more of available networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 stores information used by the image processing system, such as model parameters, training data, instructions and code libraries, stock images, previously generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, user 115 interacts with the database controller. In other cases, the database controller may operate automatically without user interaction.

Network 110 facilitates the transfer of information between image processing apparatus 100, database 105, and user 115. Network 110 may be referred to as a “cloud.” A cloud is a computer network configured to provide on-demand availability of computer system resources, such as data storage and computing power. In some examples, the cloud provides resources without active management by user 115. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User 115 may interact with the image processing system via a user interface. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI).

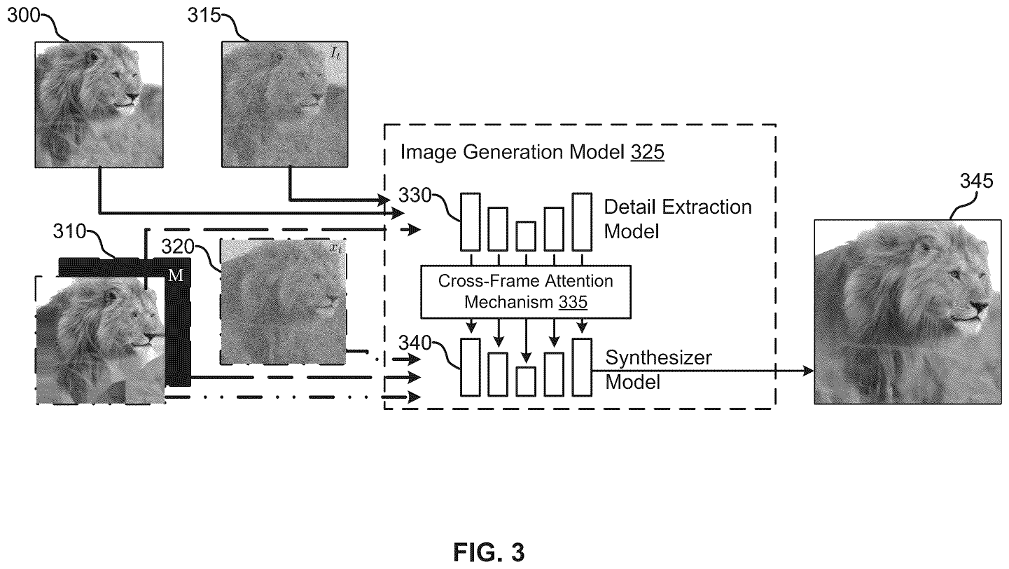

According to some aspects, image processing apparatus 100 obtains a reference image, a coarse edit image, and an occlusion mask, where the coarse edit image depicts an object from the reference image at a target position, and the occlusion mask indicates an occluded region of the coarse edit image. The image processing apparatus 100 may extract detail features from the reference image, and the detail features are used to generate a synthetic image. In some examples, image processing apparatus 100 adds noise to the reference image to obtain a noisy reference image, where the detail features are extracted based on the noisy reference image. In some aspects, the detail features are provided at a set of layers of the image generation model. Additional detail regarding the detail features will be provided with reference to FIG. 3. In some aspects, the synthetic image includes details from the reference image in a region corresponding to the occluded region of the coarse edit image.

FIG. 2 shows an example of an image processing apparatus 200 according to aspects of the present disclosure. The example shown includes image processing apparatus 200, processor unit 205, memory unit 210, I/O module 215, segmentation component 220, image generation model 225, detail extraction model 230, synthesizer model 235, training component 240, and motion model 245.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing. According to some aspects, processor unit 205 comprises one or more processors described with reference to FIG. 16.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 805 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, image processing apparatus 200 uses one or more processors of processor unit 205 to execute instructions stored in memory unit 210 to perform functions described herein. For example, the image processing apparatus 200 may generate a synthetic image depicting a seamless version of a coarse edit image, using inputs including: the coarse edit image, the unedited image (referred to sometimes as the “reference image”), and an occlusion mask, which indicates areas of missing information as a result of an editing process. The occlusion mask may be constructed automatically by an image editing software deployed in image processing apparatus 200 as a result of editing operations. The memory unit 210 may include an image generation model 225 trained to generate the synthetic image. For example, after training, the image generation model 225 may perform inferencing operations as described with reference to FIGS. 3, 4, and 8.

I/O module 215 receives inputs from and transmits outputs of the image processing apparatus 200 to other devices or users. For example, I/O module 215 receives inputs for the image generation model 225 and transmits outputs of the image generation model 225. According to some aspects, I/O module 215 is an example of the I/O interface 1620 described with reference to FIG. 16.

Segmentation component 220 is configured to perform image segmentation on an image to identify different regions of the image. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. Embodiments of the present inventive concepts may segment an image into multiple objects that can be edited (e.g., transformed), deleted, or moved by a user.

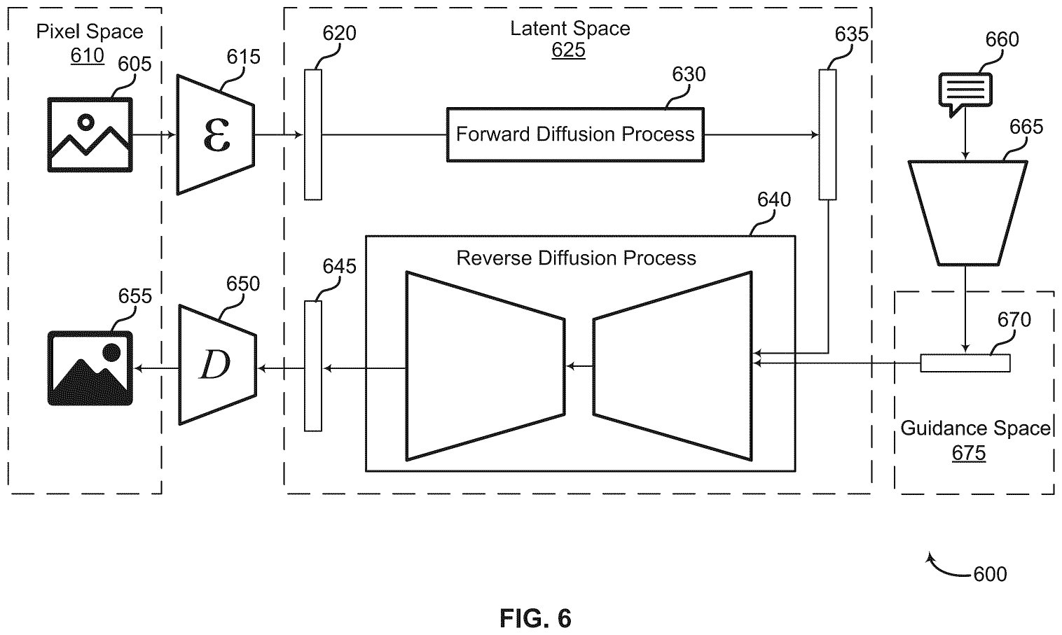

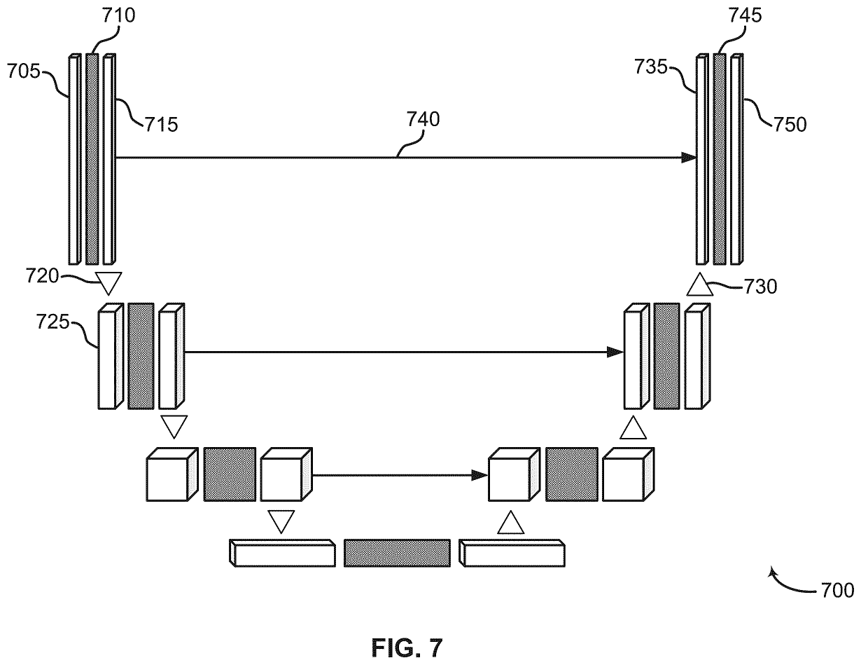

In some embodiments, the image generation model 225 is an Artificial neural network (ANN) such as the guided diffusion model described with reference to FIG. 6 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 225 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

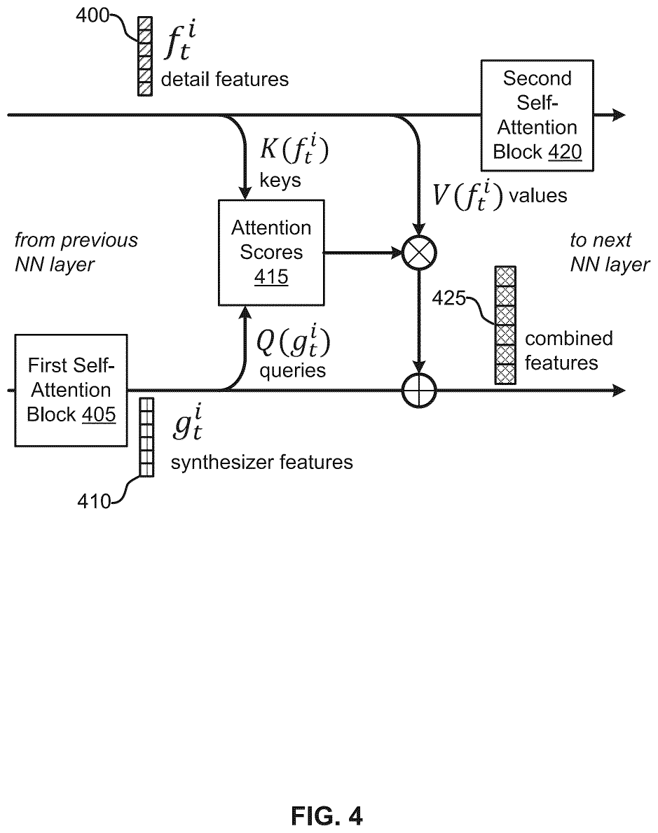

Embodiments of image generation model 225 include detail extraction model 230 and synthesizer model 235 subcomponents. Detail extraction model 230 may include an ANN implementation, such as a diffusion U-Net, that is configured to iteratively denoise an input. According to some aspects, the denoised features are not used to produce a pixel image; rather, the denoised features are applied to the generation of a synthetic image using cross-frame attention. For example, the synthesizer model 235 may be used to generate the synthetic image depicting a seamless version of an input coarse image. The synthesizer model 235 may also include a diffusion U-Net, and detail features from the detail extraction model 230 may be applied at each layer of the U-Net during the generation of the synthetic image. Additional details regarding cross-frame attention will be described with reference to FIGS. 3 and 4.

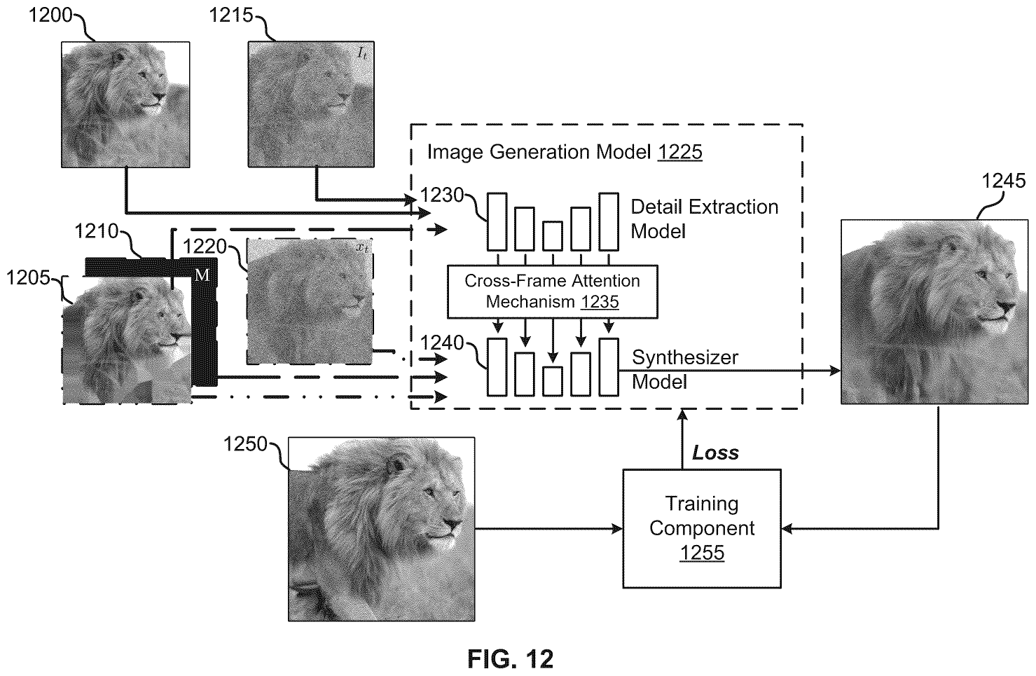

According to some aspects, image generation model 225 extracts, using a detail extraction model 230 of image generation model 225, detail features from the reference image based on the occlusion mask. In some examples, image generation model 225 generates, using a synthesizer model 235 of image generation model 225, a synthetic image depicting the object at the target position based on the coarse edit image by performing cross-frame attention between the detail features and image features representing the coarse edit image. In some examples, image generation model 225 adds noise to the coarse edit image to obtain a noisy coarse edit image, where the synthetic image is generated based on the noisy coarse edit image. Image generation model 225 is an example of, or includes aspects of, the corresponding element described with reference to FIGS. 3 and 12.

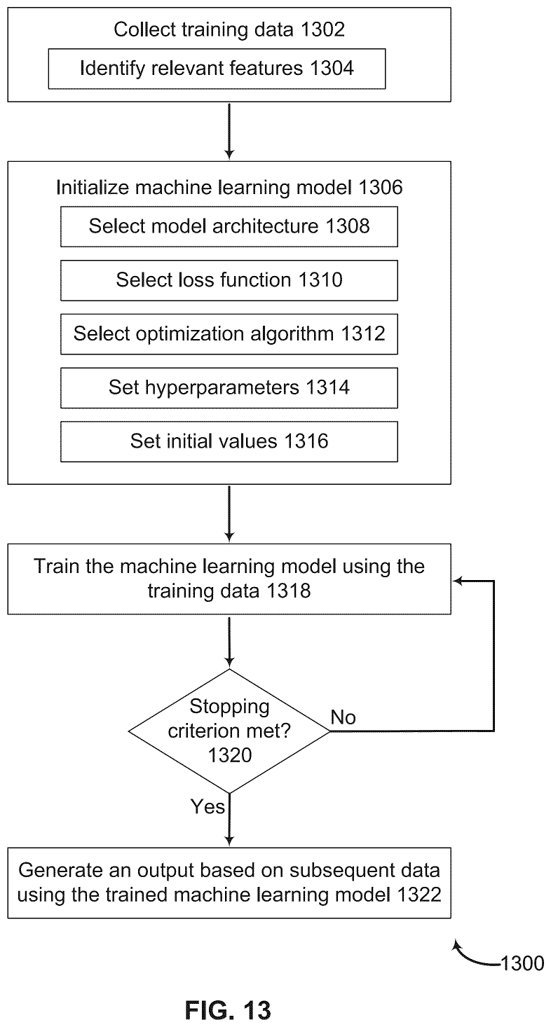

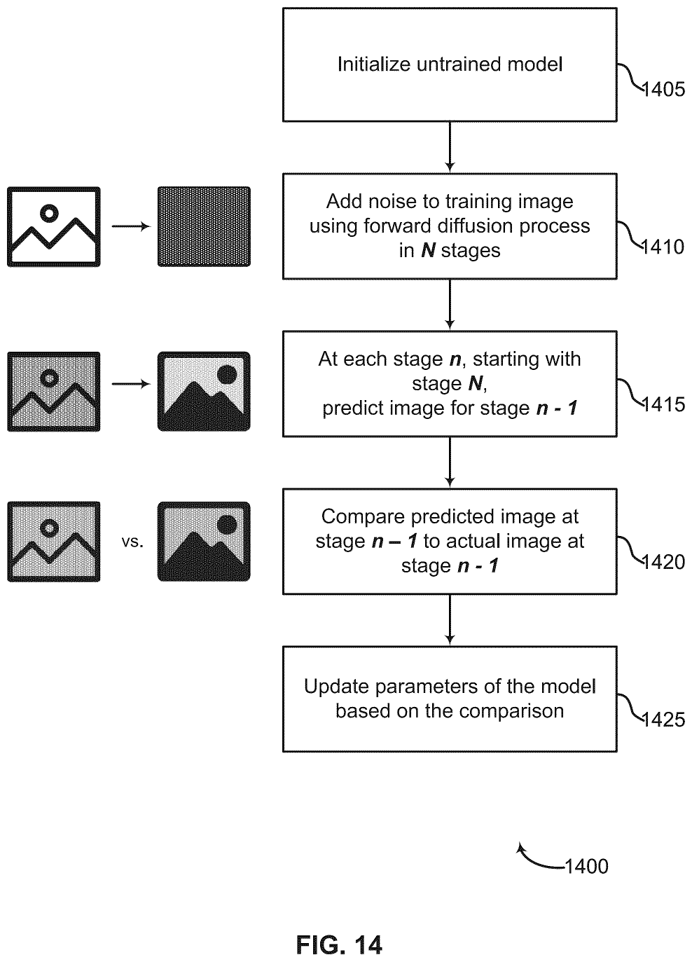

Training component 240 may train the image generation model 225. For example, parameters of the image generation model 225 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 13 and 14). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 225 can be used to make predictions on new, unseen data (i.e., during inference).

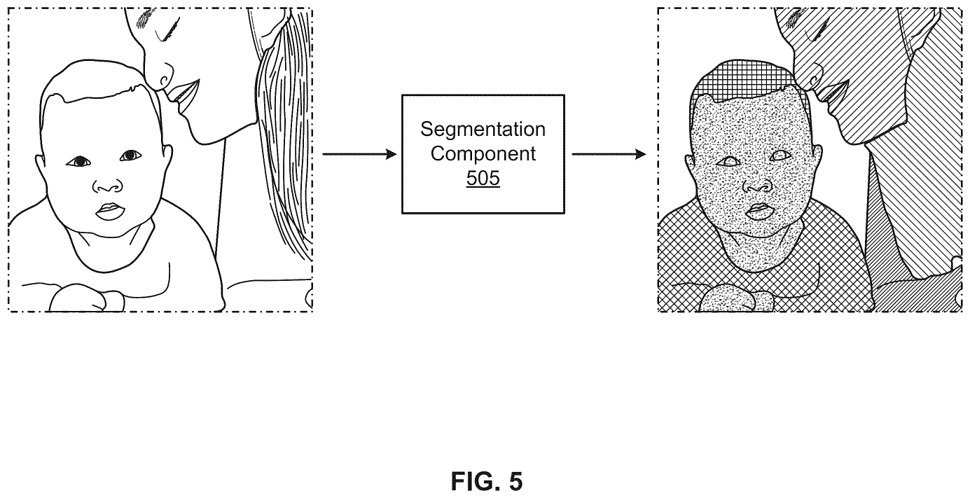

Image processing apparatus 200 is an example of, or includes aspects of, the corresponding element described with reference to FIG. 1. Segmentation component 220 is an example of, or includes aspects of, the corresponding element described with reference to FIG. 5. Detail extraction model 230 is an example of, or includes aspects of, the corresponding element described with reference to FIGS. 3 and 12. Synthesizer model 235 is an example of, or includes aspects of, the corresponding element described with reference to FIGS. 3 and 12.

Training component 240 is configured to generate training data for training image generation model 225, and to train image generation model 225 using the training data. According to some aspects, training component 240 trains image generation model 225 to generate a synthetic image depicting an object at the target position. The object may be moved to the target position by a user within an image editing application. Training component 240 may generate training data using videos. In some examples, training component 240 extracts the reference image from a first frame of the video. In some examples, training component 240 extracts the ground truth image from a second frame of the video. In some examples, training component 240 transforms the object to obtain the coarse edit image. For example, the motion model 245 may be used to simulate the coarse edit image by performing transforms on segmented regions of the reference image. In some examples, training component 240 computes a loss function based on the output image and the ground truth image. In some examples, training component 240 updates parameters of the image generation model 225 based on the loss function. Training component 240 is an example of, or includes aspects of, the corresponding element described with reference to FIG. 12. Additional detail regarding motion model 245 will be described with reference to FIG. 11.

FIG. 3 shows an example of an image generation pipeline according to aspects of the present disclosure. The example shown includes reference image 300, coarse edit image 305, occlusion mask 310, noisy reference image 315, noisy coarse edit image 320, image generation model 325, and synthetic image 345.

Image generation model 325 is an example of, or includes aspects of, the corresponding element described with reference to FIGS. 2 and 12. Detail extraction model 330 is an example of, or includes aspects of, the corresponding element described with reference to FIGS. 2 and 12. Synthesizer model 340 is an example of, or includes aspects of, the corresponding element described with reference to FIGS. 2 and 12.

In this example, the system segments reference image 300 to form non-overlapping semantic object segments. A user may edit the segmented image by applying transformations such as translation, scaling, rotation, and mirroring to the segments to form coarse edit image 305. In this example, the user moves the lion towards the right of the frame. During the editing process, the system keeps track of the holes caused by disocclusions from moving the segments in a binary mask referred to as the occlusion mask 310. In some examples, the disocclusions in coarse edit image 305 are inpainted using a rule-based or heuristic inpainting algorithm before further processing.

Image generation model 325 includes detail extraction model 330 denoted as f_{detail}, and a synthesizer model 340 denoted as f_{synth}. In some embodiments, both models adopt a diffusion U-Net architecture. The detail extraction model 330 transfers fine-grained details from reference image 300 to image generation model 325 during the generation of synthetic image 345. According to some aspects, by transferring details from reference image 300, embodiments improve the accuracy of the generation, resulting in a synthetic image 345 that has details that are more consistent with the original image. This contrasts with the semantic guidance provided by traditional multimodal encoder model such as CLIP.

Embodiments transfer the detail via cross-frame attention, which refers to a cross-attention process that considers visual features from both f_{detail} and f_{synth}. Cross-frame attention mechanism 335 is an example of, or includes aspects of, the corresponding element described with reference to FIG. 12.

According to some aspects, the system first adds noise to the reference unedited image from a Gaussian distribution [symbol] :

$${I}_{t} = \sqrt{{\overline{α}}_{t}} I + ( 1 - {\overline{α}}_{t} ) ϵ \qquad ( 1 )$$

where ϵ˜ [symbol] (0, 1)—meaning ϵ is sampled from a normal distribution with mean 0 and identity covariance matrix I, α̅ₜ refers to the forward diffusion schedule, and Iₜ is the noisy reference image 315. Cross-frame attention mechanism 335 then extracts feature tensors Fₜ. In some examples, the Fₜ are extracted before each of the self-attention blocks of f_{detail}.

The synthesizer model 340, f_{synth}, performs a reverse diffusion process to generate synthetic image 345. The generation is conditioned on the detail features Fₜ. In some embodiments, the synthesizer model 340 begins from a very noisy version of coarse edit image 305, e.g. noisy coarse edit image 320. The coarse edit image 305 may be noised thusly:

$${x}_{t} = \sqrt{{\overline{α}}_{t}} {I}_{coarse} + ( 1 - {\overline{α}}_{t} ) ϵ \qquad ( 2 )$$

In some cases, diffusion-based models may struggle to generate images whose mean and variance deviate from the normal distribution. This deviation can be significant when, for example, a user's input has an arbitrary color distribution. The synthesizer model 340 then denoises noisy coarse edit image 320 using a reverse diffusion process that incorporates cross-frame attention with the detail features Fₜ and focuses on generating missing details in the areas indicated by the occlusion mask M:

$${x}_{t - 1} = {f}_{synth} ( [ {x}_{t} , {I}_{coarse} , M ] ; t , {F}_{t} ) \qquad ( 3 )$$

Additional details regarding the reverse diffusion process are provided with respect to FIGS. 6-8. Cross-frame attention is described in additional detail with reference to FIG. 4.

FIG. 4 shows an example of cross-frame attention according to aspects of the present disclosure. The example shown includes detail features 400, first self-attention block 405, synthesizer features 410, attention scores 415, second self-attention block 420, and combined features 425. According to some aspects, the mechanism as illustrated in the Figure is performed by a cross-frame attention component as described with reference to FIG. 3.

A cross-frame attention component may combine detail features 400 with synthesizer features 410 using a cross-attention process. In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function may be used to normalize the attention weights. Finally, the attention weights are weighed together with their corresponding values. In the context of an attention network, the key and value are typically vectors or matrices that are used to represent the input data. The key is used to determine which parts of the input the attention mechanism should focus on, while the value is used to represent the actual data being processed.

In this example, the cross-frame attention component utilizes features

$${F}_{t} = [ {f}_{t}^{1} , … , {f}_{t}^{n} ] ,$$

e.g. detail features 400, extracted before the detail extraction model's self-attention block (second self-attention block 420) to transfer details from a reference image to a synthesizer model. Cross-attention is performed with features

$$[ {g}_{t}^{1} , … , {g}_{t}^{n} ] ,$$

e.g. synthesizer features 410, which are extracted after the corresponding self-attention block in the synthesizer model (first self-attention block 405). However, embodiments are not necessarily limited thereto, and the features may be extracted before or after each model's self-attention block(s) in alternative embodiments. In the Figure, Q, K, and V are linear projection layers that are used to compute the query, key, and value vectors respectively, and Wᵢ^{t} is the matrix attention scores for layer i at time step t. In this example, the feature tensors gₜⁱ, fₜⁱ are two dimensional (2D) matrices whose dimensions are the number of tokens and feature channels, which depend on the layer index i.

FIG. 5 shows an example of a segmentation component 505 according to aspects of the present disclosure. The example shown includes input image 500, segmentation component 505, and segmented image 510. Segmentation component 505 is an example of, or includes aspects of, the corresponding element described with reference to FIG. 2.

According to some aspects, segmentation component 505 performs an image segmentation on input image 500 to generate segmented image 510, which includes a plurality of editable segments. For example, a user may select a segment by clicking or tapping on the segment, and then may perform various transformations thereon such as translation, scaling, rotation, mirroring, and the like. Embodiments of segmentation component include an image encoder configured to generate a C×H×W image embedding, as well as a mask decoder configured to generate masks corresponding to segments in the input image.

FIG. 6 shows an example of a guided latent diffusion model 600 according to aspects of the present disclosure. The example shown includes guided latent diffusion model 600, original image 605, pixel space 610, image encoder 615, original image features 620, latent space 625, forward diffusion process 630, noisy features 635, reverse diffusion process 640, denoised image features 645, image decoder 650, output image 655, text prompt 660, text encoder 665, guidance features 670, and guidance space 675. According to some aspects, the image generation model described with respect to FIG. 2 includes a detail extraction model and a synthesizer model, where both models are based on guided latent diffusion models.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 600 may take an original image 605 in a pixel space 610 as input and apply and image encoder 615 to convert original image 605 into original image features 620 in a latent space 625. Then, a forward diffusion process 630 gradually adds noise to the original image features 620 to obtain noisy features 635 (also in latent space 625) at various noise levels.

Next, a reverse diffusion process 640 (e.g., a U-Net ANN) gradually removes the noise from the noisy features 635 at the various noise levels to obtain denoised image features 645 in latent space 625. In some examples, the denoised image features 645 are compared to the original image features 620 at each of the various noise levels, and parameters of the reverse diffusion process 640 of the diffusion model are updated based on the comparison. Finally, an image decoder 650 decodes the denoised image features 645 to obtain an output image 655 in pixel space 610. In some cases, an output image 655 is created at each of the various noise levels. The output image 655 can be compared to the original image 605 to train the reverse diffusion process 640.

In some cases, image encoder 615 and image decoder 650 are pre-trained prior to training the reverse diffusion process 640. In some examples, they are trained jointly, or the image encoder 615 and image decoder 650 and fine-tuned jointly with the reverse diffusion process 640.

The reverse diffusion process 640 can also be guided based on a text prompt 660, or another guidance prompt, such as an image, a layout, a segmentation map, etc. The text prompt 660 can be encoded using a text encoder 665 (e.g., a multimodal encoder) to obtain guidance features 670 in guidance space 675. The guidance features 670 can be combined with the noisy features 635 at one or more layers of the reverse diffusion process 640 to ensure that the output image 655 includes content described by the text prompt 660. For example, guidance features 670 can be combined with the noisy features 635 using a cross-attention block within the reverse diffusion process 640.

FIG. 7 shows an example of a U-Net 700 according to aspects of the present disclosure. In some examples, U-Net 700 is an example of the component that performs the reverse diffusion process 625 of guided diffusion model 600 described with reference to FIG. 6, and includes architectural elements of the image generation model 225 described with reference to FIG. 2. The U-Net 700 depicted in FIG. 7 is an example of, or includes aspects of, the architecture used within the reverse diffusion process described with reference to FIG. 6.

In some examples, diffusion models are based on a neural network architecture known as a U-Net. The U-Net 700 takes input features 705 having an initial resolution and an initial number of channels, and processes the input features 705 using an initial neural network layer 710 (e.g., a convolutional network layer) to produce intermediate features 715. The intermediate features 715 are then down-sampled using a down-sampling layer 720 such that down-sampled features 725 have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having a same resolution and number of channels via a skip connection 740. These inputs are processed using a final neural network layer 745 to produce output features 750. In some cases, the output features 750 have the same resolution as the initial resolution and the same number of channels as the initial number of channels.

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715.

### Generating Synthetic Images

FIG. 8 shows a diffusion process 800 according to aspects of the present disclosure. In some examples, diffusion process 800 describes an operation of the image generation model 225 described with reference to FIG. 2, such as the reverse diffusion process 625 of guided diffusion model 600 described with reference to FIG. 6.

As described above with reference to FIG. 6, using a diffusion model can involve both a forward diffusion process 805 for adding noise to an image (or features in a latent space) and a reverse diffusion process 810 for denoising the images (or features) to obtain a denoised image. The forward diffusion process 805 can be represented as q(xₜ|xₜ₋₁), and the reverse diffusion process 810 can be represented as p(xₜ₋₁|xₜ). In some cases, the forward diffusion process 805 is used during training to generate images with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data XT, such as a noisy image 815 and denoises the data to obtain the p(xₜ₋₁|xₜ). At each step t−1, the reverse diffusion process 810 takes xₜ, such as first intermediate image 820, and t as input. Here, t represents a step in the sequence of transitions associated with different noise levels, The reverse diffusion process 810 outputs xₜ₋₁, such as second intermediate image 825 iteratively until x_{T} reverts back to x₀, the original image 830. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 4 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 5 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

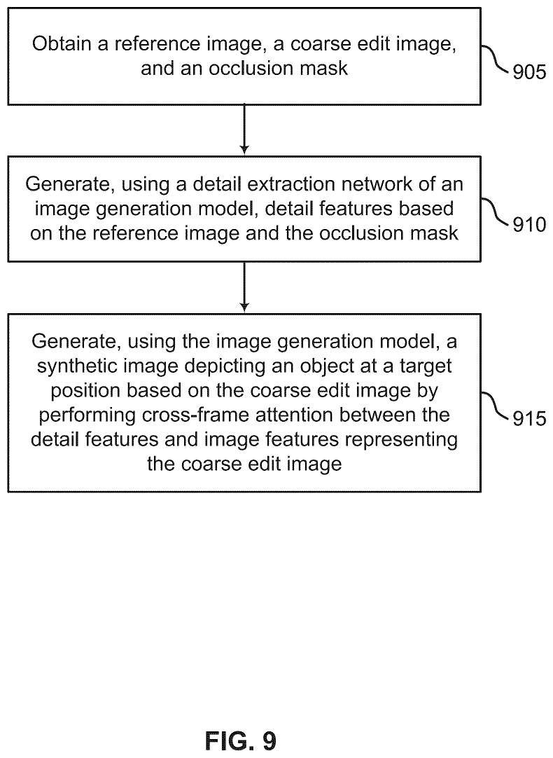

FIG. 9 shows an example of a method 900 for generating a synthetic image based on a coarse edit image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains a reference image, a coarse edit image, and an occlusion mask. In some cases, the operations of this step refer to, or may be performed by, an image processing apparatus as described with reference to FIGS. 1 and 2. The coarse edit image depicts an object from the reference image at a target position, and the occlusion mask indicates an occluded region of the coarse edit image. For example, the reference image may be an unedited image. The reference image may be segmented by the image processing apparatus using a segmentation component. A user may perform transformations on segments such as rotations, scaling, movements, duplications, and the like. In this way, the user moves an object to a target position, which is represented in the coarse edit image. The occlusion mask keeps track of the holes caused by disocclusions from moving the segments. According to some aspects, the user performs these edits within an image editing software that includes a GUI.

At operation 910, the system extracts, using a detail extraction model of an image generation model, detail features from the reference image based on the occlusion mask. In some cases, the operations of this step refer to, or may be performed by, an image generation model as described with reference to FIGS. 2, 3, and 12. For example, the detail extraction model may be a diffusion U-Net that performs a denoising operation on a noised version of the reference image, where the detail features are extracted during the denoising operation. Additional detail regarding this process is provided with reference to FIG. 3.

At operation 915, the system generates, using the image generation model, a synthetic image depicting the object at the target position based on the coarse edit image by performing cross-frame attention between the detail features and image features representing the coarse edit image. In some cases, the operations of this step refer to, or may be performed by, an image generation model as described with reference to FIGS. 2, 3, and 12. Additional detail regarding the cross-frame attention mechanism is provided with reference to FIG. 4.

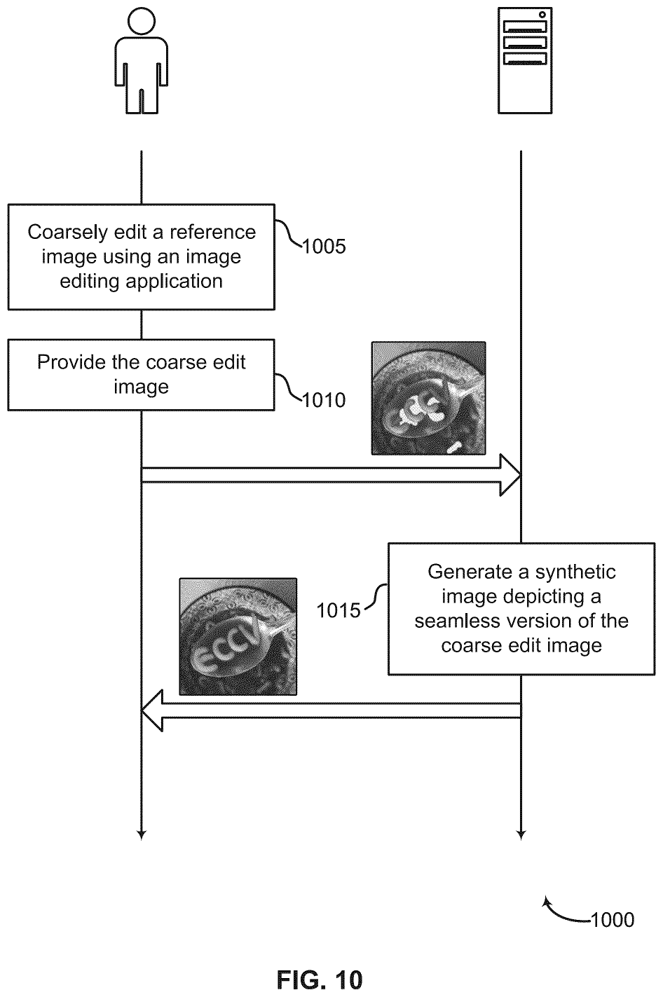

FIG. 10 shows an example of a method 1000 for providing a synthetic image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, a user coarsely edits a reference image using an image editing application. Embodiments of the image editing application include a GUI. For example, the user may hover over the image, and the GUI may provide visual indicators over each of the available segments in the image. In some embodiments, the user identifies the segments themselves, by using a lasso selection tool, a quick-selection tool, or the like.

At operation 1010, the user provides the coarse edit image. For example, the user may select an element of the GUI that is used to proceed with the image processing, such as a “Clean Up” button or the like.

At operation 1015, the system generates a synthetic image depicting a seamless version of the coarse edit image. The system processes the unedited version, the coarse edit image, and an occlusion mask to generate the synthetic image. A detailed description of this generation pipeline is provided with reference to FIG. 3.

### Training

FIG. 11 shows an example of a pipeline for generating image generation data according to aspects of the present disclosure. The example shown includes segmented image 1100, target image 1105, motion model 1110, coarse edit image 1115, and occlusion mask 1120. Motion model 1110 is an example of, or includes aspects of, the corresponding element described with reference to FIG. 2.

In this example, motion model 1110 generates a simulated coarse edit image 1115 and occlusion mask 1120 for use in training the image generation model. Specifically, the image generation model is trained to generate a seamless version of the coarse edit image based on coarse edit image 1115, occlusion mask 1120, and a reference image (an unedited version of the coarse edit image—for example, segmented image 1100 before the segmentation process).

In some cases, the segmented image 1100 is a first frame of a video that is processed by an image segmentation component. Target image 1105 is a ground-truth target for the image generation model to aspire to generate, and is a second frame of a video. For example, target image 1105 includes the same elements of segmented image 1100, but moved slightly due to the natural movements within the video. Motion model 1110 identifies the differences in positions of the objects between the two frames, and generates coarse edit image 1115 and occlusion mask 1120 based on these differences.

According to some aspects, using image pairs obtained from videos provides useful information during the training of the image generation model. Videos include data that observes the same object in diverse backgrounds, lights, and surfaces. For example, skin can wrinkle as a person flexes their arm, their clothes crease in complex ways, and the grass underneath their feet reacts with each step. Further, camera motion yields disocclusion cues and multiple observations of the same scene from different views.

In an example, a training tuple includes a reference image, a ground truth image, a coarse edit image, and an occlusion mask—(I, I_{gt}, I_{coarse}, M), respectively. The reference image and the ground truth image may be extracted from a video with a time interval between the corresponding frames that is sampled uniformly at random from {1 . . . 10} seconds. In some cases, the frames are resampled if a computed optical flow between the frames is too large, e.g., at least 10% of the image has a flow magnitude over 350 pixels (or some percentage of the image height or width).

Embodiments of motion model 1110 include a piecewise affine motion model. In this case, the motion model 1110 transforms an input image into a collage, e.g. segmented image 1100. Embodiments compute a depth map of the input image and then perform image segmentation, such as panoptic image segmentation. Then, the motion model 1110 transforms each segment that best matches the movement of the objects between I and I_{gt}. In some cases, the motion model 1110 composites the segments back to front according to each segment's average depth. In at least one embodiment, the motion model 1110 utilizes a flow-based motion model, wherein embodiments compose flow vectors by backward warping the flow from the ground-truth image to the reference image. Then, embodiments forward warp I to obtain I_{coarse}. In some aspects, the forward warping process creates holes in the image, and these holes are recorded in the occlusion mask M. In some cases, motion model 1110 uses a combination of the piecewise affine motion model and the flow-based motion model. In this way, motion model 1110 simulates I_{coarse} and M based on the reference image/and the ground truth image I_{gt}, thereby forming training data (I, I_{gt}, I_{coarse}, M).

FIG. 12 shows an example of training pipeline according to aspects of the present disclosure. The example shown includes reference image 1200, coarse edit image 1205, occlusion mask 1210, noisy reference image 1215, noisy coarse edit image 1220, image generation model 1225, synthetic image 1245, ground truth image 1250, and training component 1255. Image generation model 1225 is an example of, or includes aspects of, the corresponding element described with reference to FIGS. 2 and 3. Training component 1255 is an example of, or includes aspects of, the corresponding element described with reference to FIG. 2.

FIG. 12 illustrates the same or similar components as the pipeline illustrated in FIG. 3, and differences therebetween will be mainly described. The training pipeline includes the training data described with reference to FIG. 11, (I, I_{gt}, I_{coarse}, M)—respectively, the reference image 1200, ground truth image 1250, coarse edit image 1205, and occlusion mask 1210. The reference image 1200 may be obtained from a first frame of a video, and the coarse edit image 1205 may be a simulated edited version of reference image 1200. For example, a motion model as described with reference to FIG. 11 may generate the coarse edit image 1205, as well as the occlusion mask 1210. The ground truth image 1250 may be obtained from a second frame of the video. The ground truth image 1250 represents a target for the image generation model 1225 to aspire to based on the inputs including the reference image 1200, coarse edit image 1205, and the occlusion mask 1210.

The training component 1255 compares synthetic image 1245 to ground truth image 1250, and computes a loss function based on the comparison. The training component 1255 may then update parameters of image generation model 1225, including the detail extraction model 1230 and the synthesizer model 1240, by backpropagating the loss function. In this way, the training pipeline trains the image generation model 1225 to generate a seamless version of coarse edit images. According to some aspects, including the occlusion mask 1210 as an input teaches the image generation model 1225 to focus on the occluded regions of coarse edited images and to add detail specifically thereto.

FIG. 13 shows an example of a training algorithm for a machine learning model according to aspects of the present disclosure. In some embodiments, the procedure 1300 describes an operation of the training component 240 described for configuring the image generation model 225 as described with reference to FIG. 2. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth. For example, synthetic data generation techniques are described with reference to FIG. 11.

The machine-learning system is also configurable to identify features that are relevant (block 1304) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. The image generation model described with reference to FIG. 2 may include a diffusion U-Net architecture.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth. In some embodiments, the training component computes a perceptual loss such as LPIPS between the synthetic image generated by the image generation model and the ground truth model.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore once trained is configured to perform that task based on subsequent data received as an input and processed by the machine-learning model.

FIG. 14 shows an example of a method 1400 for training a diffusion model according to aspects of the present disclosure. In some embodiments, the method 1400 describes an operation of the training component 240 described for configuring the image generation model 225 as described with reference to FIG. 2. The method 1400 represents an example for training a reverse diffusion process as described above with reference to FIG. 4. In some examples, these operations are performed by a system including a processor executing a set of codes to control functional elements of an apparatus, such as the guided diffusion model described in FIG. 1. The method 1400 may be used in a pre-training phase for initializing a detail extraction model and/or a synthesizer model as described herein.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1415, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1420, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log pe (x) of the training data.

At operation 1425, the system updates parameters of the model based on the comparison. For example, parameters of a U-Net may be updated using gradient descent. Time-dependent parameters of the Gaussian transitions can also be learned.

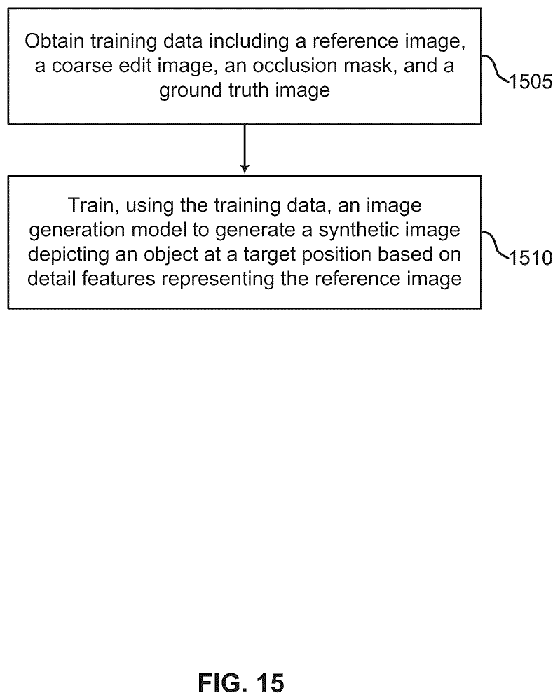

FIG. 15 shows an example of a method 1500 a method for training a machine learning model to generate synthetic images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1505, the system obtains training data including a reference image, a coarse edit image, an occlusion mask, and a ground truth image, where the coarse edit image depicts an object from the reference image at a target position, the occlusion mask indicates an occluded region of the coarse edit image, and the ground truth image depicts the object at the target position. In some cases, the operations of this step refer to, or may be performed by, an image processing apparatus as described with reference to FIGS. 1 and 2.

The reference image represents an unedited version of an image, and may be selected from a first frame of a video. The coarse edit image represents an edited version of the image, e.g., a version of the image after a user has moved or otherwise transformed one or more elements in the image. The coarse edit image may be generated using a motion model as described in FIG. 11. The occlusion mask may also be generated using the motion model, and indicates the areas of missing information in the original image after editing operations are performed thereon. The ground truth image depicts the ideal target for an image generation model to generate based on the inputs including the reference image, the coarse edit image, and the occlusion mask. The ground truth image may be selected from a second frame of the video, chosen from a different timestamp in the video than the first frame.

At operation 1510, the system trains, using the training data, an image generation model to generate a synthetic image depicting the object at the target position based on detail features representing the reference image. In some cases, the operations of this step refer to, or may be performed by, a training component as described with reference to FIGS. 2 and 12. The training component may quantify differences between a synthetic image computed by the image generation model and the ground truth image by computing a loss function, and then update parameters of the image generation model based on the loss function. The image generation model generate (in this context, “predict”) the synthetic image by generating the image using a synthesizer model that utilizes detail features extracted from the reference image by a detail extraction model. Additional detail regarding training is provided with reference to FIG. 12, and additional detail regarding the detail transfer is provided with reference to FIGS. 3-4.

FIG. 16 shows an example of a computing device 1600 according to aspects of the present disclosure. The computing device 1600 may be an example of the image processing apparatus 200 described with reference to FIG. 2. In one aspect, computing device 1600 includes processor(s) 1605, memory subsystem 1610, communication interface 1615, I/O interface 1620, user interface component(s) 1625, and channel 1630.

In some embodiments, computing device 1600 is an example of, or includes aspects of the image processing apparatus of FIGS. 1-2. In some embodiments, computing device 1600 includes one or more processors 1605 that can execute instructions stored in memory subsystem 1610 to perform image generation.

According to some aspects, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some aspects, user interface component(s) 1625 enable a user to interact with computing device 1600. In some cases, user interface component(s) 1625 include an audio device, such as an external speaker system, an external display device such as a display screen, an input device (e.g., a remote control device interfaced with a user interface directly or through the I/O controller), or a combination thereof. In some cases, user interface component(s) 1625 include a GUI.

Accordingly, the present disclosure includes the following aspects.

A method for image generation is described. One or more aspects of the method include obtaining a reference image, a coarse edit image, and an occlusion mask, wherein the coarse edit image depicts an object from the reference image at a target position, and the occlusion mask indicates an occluded region of the coarse edit image; extracting, using a detail extraction model of an image generation model, detail features from the reference image based on the occlusion mask; and generating, using the image generation model, a synthetic image depicting the object at the target position based on the coarse edit image by performing cross-frame attention between the detail features and image features representing the coarse edit image.

Some examples of the method, apparatus, non-transitory computer readable medium, and system further include segmenting the reference image to identify a region corresponding to the object at an original position different from the target position. Some examples further include transforming the object to obtain the coarse edit image.

Some examples of the method, apparatus, non-transitory computer readable medium, and system further include generating the occlusion mask based on the reference image and the transformation of the object. Some examples further include adding noise to the reference image to obtain a noisy reference image, wherein the detail features are generated based on the noisy reference image.

Some examples of the method, apparatus, non-transitory computer readable medium, and system further include adding noise to the coarse edit image to obtain a noisy coarse edit image, wherein the synthetic image is generated based on the noisy coarse edit image. In some aspects, the detail features are provided at a plurality of layers of the image generation model. In some aspects, the synthetic image includes details from the reference image in a region corresponding to the occluded region of the coarse edit image.

A method for image generation is described. One or more aspects of the method include obtaining training data including a reference image, a coarse edit image, an occlusion mask, and a ground truth image, wherein the coarse edit image depicts an object from the reference image at a target position, the occlusion mask indicates an occluded region of the coarse edit image, and the ground truth image depicts the object at the target position and training, using the training data, an image generation model to generate a synthetic image depicting the object at the target position based on detail features representing the reference image.

Some examples of the method, apparatus, non-transitory computer readable medium, and system further include obtaining a video. Some examples further include extracting the reference image from a first frame of the video. Some examples further include extracting the ground truth image from a second frame of the video.

Some examples of the method, apparatus, non-transitory computer readable medium, and system further include segmenting the reference image to identify a region corresponding to the object at an original position different from the target position. Some examples further include transforming the object to obtain the coarse edit image.

In some aspects, the object is transformed using a motion model. Some examples of the method, apparatus, non-transitory computer readable medium, and system further include generating the occlusion mask based on the reference image and the transformation of the object.

Some examples of the method, apparatus, non-transitory computer readable medium, and system further include generating an output image based on the reference image, the coarse edit image, and the occlusion mask. Some examples further include computing a loss function based on the output image and the ground truth image. Some examples further include updating parameters of the image generation model based on the loss function.

An apparatus for image generation is described. One or more aspects of the apparatus include at least one processor; at least one memory storing instructions executable by the at least one processor; and an image generation model comprising parameters stored in the at least one memory and trained to extract detail features from a reference image and an occlusion mask, and to generate a synthetic image based on a coarse edit image that depicts an object from the reference image at a target position, wherein the synthetic image depicts the object at the target position. In some aspects, the image generation model comprises a diffusion network.

In some aspects, the image generation model further comprises a detail extraction model trained to extract the detail features. In some aspects, the image generation model comprises a cross-attention layer trained to perform cross-frame attention between the detail features and image features representing the coarse edit image.

Some examples of the apparatus, system, and method further include a motion model configured to generate training data for the image generation model. Some examples of the apparatus, system, and method further include a segmentation component configured to segment the reference image. Some examples of the apparatus, system, and method further include an image editing application configured to generate the coarse edit image. Embodiments of the image editing application comprise a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a reference image, a coarse edit image, and an occlusion mask, wherein the coarse edit image depicts an object from the reference image at a target position, and the occlusion mask indicates an occluded region of the coarse edit image;
extracting, using a detail extraction model of an image generation model, detail features from the reference image based on the occlusion mask; and
generating, using the image generation model, a synthetic image depicting the object at the target position based on the coarse edit image by performing cross-frame attention between the detail features and the coarse edit image.

2. The method of claim 1, wherein obtaining the coarse edit image comprises:
segmenting the reference image to identify a region corresponding to the object at an original position different from the target position; and
transforming the object to obtain the coarse edit image.

3. The method of claim 2, further comprising:
generating the occlusion mask based on the reference image and the transformation of the object.

4. The method of claim 1, further comprising:
adding noise to the reference image to obtain a noisy reference image, wherein the detail features are extracted based on the noisy reference image.

5. The method of claim 1, further comprising:
adding noise to the coarse edit image to obtain a noisy coarse edit image, wherein the synthetic image is generated based on the noisy coarse edit image.

6. The method of claim 1, wherein:
the detail features are provided at a plurality of layers of the image generation model.

7. The method of claim 1, wherein:
the synthetic image includes details from the reference image in a region corresponding to the occluded region of the coarse edit image.

8. A method of training a machine learning model, the method comprising:
obtaining training data including a reference image, a coarse edit image, an occlusion mask, and a ground truth image, wherein the coarse edit image depicts an object from the reference image at a target position, the occlusion mask indicates an occluded region of the coarse edit image, and the ground truth image depicts the object at the target position; and
training, using the training data, an image generation model to generate a synthetic image depicting the object at the target position based on detail features representing the reference image.

9. The method of claim 8, wherein obtaining the training data comprises:
obtaining a video;
extracting the reference image from a first frame of the video; and
extracting the ground truth image from a second frame of the video.

10. The method of claim 8, wherein obtaining the training data comprises:
segmenting the reference image to identify a region corresponding to the object at an original position different from the target position; and
transforming the object to obtain the coarse edit image.

11. The method of claim 10, wherein:
the object is transformed using a motion model.

12. The method of claim 10, wherein obtaining the training data comprises:
generating the occlusion mask based on the reference image and the transformation of the object.

13. The method of claim 10, wherein training of the image generation model comprises:
generating an output image based on the reference image, the coarse edit image, and the occlusion mask;
computing a loss function based on the output image and the ground truth image; and
updating parameters of the image generation model based on the loss function.

14. An apparatus comprising:
at least one processor;
at least one memory storing instructions executable by the at least one processor; and
the apparatus further comprising an image generation model comprising parameters stored in the at least one memory and trained to extract detail features from a reference image and an occlusion mask, and to generate a synthetic image based on a coarse edit image that depicts an object from the reference image at a target position, wherein the synthetic image depicts the object at the target position.

15. The apparatus of claim 14, wherein:
the image generation model further comprises a detail extraction model trained to extract the detail features.

16. The apparatus of claim 14, wherein:
the image generation model comprises a cross-attention layer trained to perform cross-frame attention between the detail features and image features representing the coarse edit image.

17. The apparatus of claim 14, further comprising:
a motion model configured to generate training data for the image generation model.

18. The apparatus of claim 14, further comprising:
an image editing application configured to generate the coarse edit image.

19. The apparatus of claim 14, wherein:
the image generation model comprises a diffusion network.

20. The apparatus of claim 14, further comprising:
a segmentation component configured to segment the reference image.
